(19) United States
(12) Patent Application Publication
(10) Pub. No.: US 2026/0067885 A1
(43) Pub. Date: Mar. 5, 2026

(54) ADVERTISING PERIODIC BROADCAST AND UNICAST MAC ROTATION OPPORTUNITY INDICATION

(71) Applicant: Cisco Technology, Inc., San Jose, CA (US)

(72) Inventors: Sachin D. WAKUDKAR, St-Sulpice (CH); Domenico FICARA, Essertines-Sur-Yverdon (CH); Jerome HENRY, Pittsboro, NC (US)

(21) Appl. No.: 19/281,631

(22) Filed: Jul. 26, 2025

Related U.S. Application Data
(60) Provisional application No. 63/689,404, filed on Aug. 30, 2024.

(51) Int. Cl. H04W 72/12; H04W 88/08

(52) U.S. Cl. CPC H04W 72/12; H04W 88/08

(57) ABSTRACT

Rotating a MAC address of a target STA to avoid being tracked by a nefarious actor. An AP sends a signal with multiple schedules to the target STA, each with a different timing to rotate the MAC address. The target STA can choose to use one of the schedules, use none of the schedules, or ask the AP to provide a modified schedule for the target STA to use. The AP can send another signal to the target STA with multiple schedules including the modified schedule.

### CROSS-REFERENCE TO RELATED APPLICATIONS

This application claims benefit of co-pending U.S. provisional patent application Ser. No. 63/689,404 filed Aug. 30, 2024. The aforementioned related patent application is herein incorporated by reference in its entirety.

### TECHNICAL FIELD

Embodiments presented in this disclosure generally relate to maintaining privacy of communication between an Access Point (AP) and a station (STA). More specifically, embodiments disclosed herein rotating a MAC address of a STA to avoid being tracked.

### BACKGROUND

STAs often connect wirelessly to an AP in order to access a network. The STAs may transmit signals to, and receive signals, from the AP as the STAs use the network. Each of these signals can include an indicator of a specific STA that is transmitting signals to, or receiving signals from, the AP.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts a diagram of an AP communicating rotation schedules with multiple STAs, according to one embodiment.

FIG. 2A depicts an exemplary broadcast beacon from an AP to a plurality of stations, according to one embodiment.

FIG. 2B depicts an exemplary unicast signal from an AP to a STA, according to one embodiment.

FIG. 2C depicts an exemplary communication between a STA and an AP for a MAC address rotation schedule, according to one embodiment.

FIG. 2D depicts an exemplary embodiment of an AP polling to see which STAs are active to send MAC address rotation schedules, according to one embodiment.

FIG. 3 depicts a flowchart of an exemplary method of transmitting MAC address rotation schedules to a STA, according to one embodiment.

FIG. 4 depicts a flowchart of an exemplary method of using a wake time to schedule when a STA should rotate its MAC address, according to one embodiment.

FIG. 5 depicts an example network device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is an AP that includes one or more memories, and one or more processors communicatively coupled to the one or more memories, with the one or more processors configured to, individually or collectively, perform an operation. The AP further includes transmitting a signal with multiple schedules for rotating a MAC address on a target station, with each of the multiple schedules including a different timing for rotating the MAC address and monitoring the target station for a change in the MAC address. The embodiments may also include a method.

One embodiment presented in this disclosure is an AP that includes one or more memories, and one or more processors communicatively coupled to the one or more memories, with the one or more processors configured to, individually or collectively, perform an operation. The AP further includes transmitting a first signal to each one of multiple stations including multiple schedules each with a different target wake time (TWT), which the different TWTs indicate when a respective one of the multiple stations should be awake or be in a power save mode. The AP further includes scheduling a second signal to be transmitted to at least one of the multiple stations in response to reaching a TWT indicating that the at least one of the multiple stations should wake up and rotate a MAC address.

### Example Embodiments

This disclosure relates to rotating a MAC address for a STA that is associated with an AP associated with a network. As the STA transmits messages to the AP, the messages include information about the STA including a MAC address for the STA, which is one example of an indicator that is specific to the STA. A nefarious actor may monitor the communication between the STA and the AP to use information about the STA, such as the MAC address, to mimic messages sent from the STA. Using the MAC address of the STA, the nefarious actor can send messages to the AP acting as the STA, which could potentially cause problems for the AP or STA. However, by rotating the MAC address on the STA, the nefarious actor would be sending messages to the AP with an old MAC address, so the AP would know that the message did not come from the real STA.

For the STA to rotate its MAC address, in one embodiment the AP sends a signal to the STA that includes multiple MAC address rotation schedules, each with different timings. The AP may send the multiple MAC address rotation schedules in a broadcast signal to multiple STAs or in a unicast signal to one target STA. When the STA receives the signal, the STA can choose to use any of the MAC addresses rotation schedules or to use none of the MAC addresses rotation schedules. Additionally, the STA could request the AP to send a modified version of one of the MAC addresses rotation schedules, e.g., as part of a negotiation with the AP. When the AP receives the request from the STA, the AP may send a unicast signal back to the STA with the multiple MAC addresses rotation schedules and the modified version of the one of the MAC address rotation schedules.

In one embodiment, the AP transmits multiple TWT schedules to multiple STAs such that each STA can join one TWT schedule. Each of the TWT schedules includes different timings for when the STAs should be awake and when the STAs should be in a power save mode. The AP uses the TWT schedules to determine when the STAs should rotate its MAC address based on when the STAs should be awake. When the TWT occurs for one of the TWT schedules, the AP transmits a signal to the STAs opting into the respective TWT schedule indicating the STAs should rotate its respective MAC address.

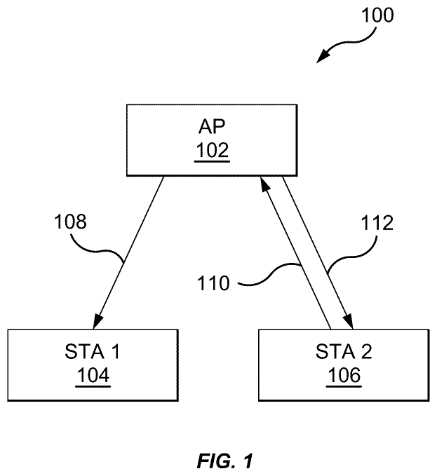

FIG. 1 depicts a diagram of a system 100 with an AP 102 communicating MAC address rotation schedules with multiple STAs (STA 104 and 106). The STA 104 and 106 may associate with the AP 102 to connect to a network that the AP 102 is part of. The STAs 104 and 106 may be client devices (e.g., a laptop, a desktop computer, a smartphone, a tablet, and the like). Each of the STAs 104 and 106 includes a MAC address that is used that is part of communications from the STA 104 or 106 to the AP 102. The MAC address is used to identify the STA that sent the communication, so the AP 102 knows which STA to send a reply to.

A nefarious actor may monitor the communications between the AP 102 and the STAs 104 and 106 to obtain information about the STAs 104 and 106 such as the respective MAC addresses. The nefarious actor may use the MAC address of the STA 104 or 106 to mimic sending a message on behalf of one of the STAs 104 or 106 to the AP 102. To help prevent the nefarious actor from using the MAC address of one of the STAs 104 or 106 to send messages, the AP 102 may send MAC address rotation schedules to the STAs 104 or 106 to change the respective MAC address. In one embodiment, the AP 102 sends multiple MAC address rotation schedules to the STAs 104 and 106 as the STAs 104 and 106 associate with the AP 102. In an exemplary embodiment, the AP 102 sends a unicast signal 108 with multiple MAC address rotation schedules to the STA 104. The unicast signal 108 may be sent after a configurable amount of time has passed (e.g., an amount of time since the STA 104 associated with the AP 102 or an amount of time since the STA 104 changed its MAC address). Each of the multiple MAC address rotation schedules includes a different timing for rotating the MAC address of the STA 104 and an amount of time that the MAC address rotation schedules are valid. The amount of time that passed and the timing of the rotation schedules may be in terms of seconds, a number of beacons from the AP 102, etc. If the STA 104 opts into one of the multiple MAC address rotation schedules, the STA 104 changes its MAC address after a period of time. The AP 102 may monitor the STA 104 for changes in its MAC address to determine if the STA 104 changed its MAC address. In one embodiment, as the AP 102 is monitoring the STA 104, if the STA 104 does not change its MAC address after the configurable amount of time, the AP 102 will resend the multiple MAC address rotation schedules. If the STA 104 rotates its MAC address, the AP 102 waits the configurable amount of time from when the STA 104 rotates its MAC address before resending the multiple MAC address rotation schedules. The AP 102 may reset the time that it waits based on when STA 104 rotates its MAC address.

Instead of waiting for the AP 102 to send the multiple MAC addresses, a station associated with the AP 102 may request a MAC address rotation schedule from the AP 102. In an exemplary embodiment, the STA 106 sends a request 110 to the AP requesting a MAC address rotation schedule. The AP 102 may send a response to the request 110 in a response 112 with multiple MAC address rotation schedules for the STA 106 to choose from.

In response to either the unicast signal 108 or the response 112, the STA 104 or STA 106, respectively, may send a signal to the AP 102 requesting a rotation schedule that is different from the multiple MAC address rotation schedules the AP 102 sent. The different rotation schedule may be a modification of one of the multiple MAC address rotation schedules that the AP 102 sent or a new MAC address rotation schedule that is different from any of the MAC address rotation schedules that the AP 102 sent. In one embodiment, the AP 102 generates the new MAC address rotation schedule based on a number of STAs associated with the AP 102. For example, if there are ten STAs associated with the AP 102, the new MAC address rotation schedule would be a slower rotation schedule than if there is one STA associated with the AP 102. By having more STAs associated with the AP 102, it would be harder for a nefarious actor to track the MAC addresses of each STA.

In one embodiment, the AP 102 generates the new MAC address rotation schedule based on traffic going to and from the STA that requested the new MAC address rotation schedule. For example, if the STA 104 has a low amount of traffic going to and from the STA 104, the new MAC address rotation schedule would be a faster rotation schedule than if the STA 104 has a high amount of traffic. By having less traffic going to and from the STA 104, when the STA 104 rotates its MAC address, there would be less chance of issues with signals mixing up MAC addresses for the STA 104. In one embodiment, the AP 102 generates the new MAC address rotation schedule based on the number of STAs associated with the AP 102 and the traffic going to and from the STA that requested the new MAC address rotation schedule. The AP 102 may send the new MAC address rotation schedule along with the multiple MAC address rotation schedules back to the STA 104 or 106 that requested the new MAC address rotation schedule. If several STAs associated with the AP 102 request a new MAC address rotation schedule, the AP 102 may add the new MAC address rotation schedule to the multiple MAC address rotation schedules to transmit to STAs. In one embodiment, the AP 102 broadcasts the new MAC address rotation schedule and the MAC address rotation schedules to each of the STAs associated with the AP 102.

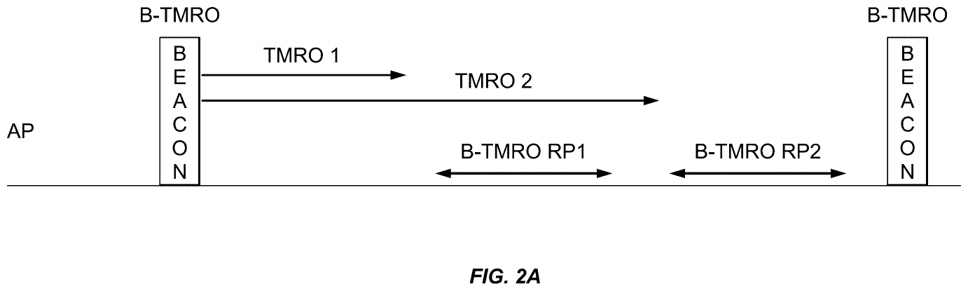

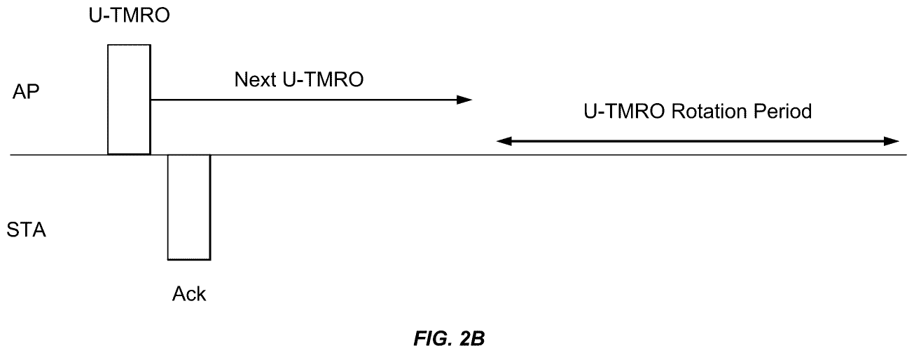

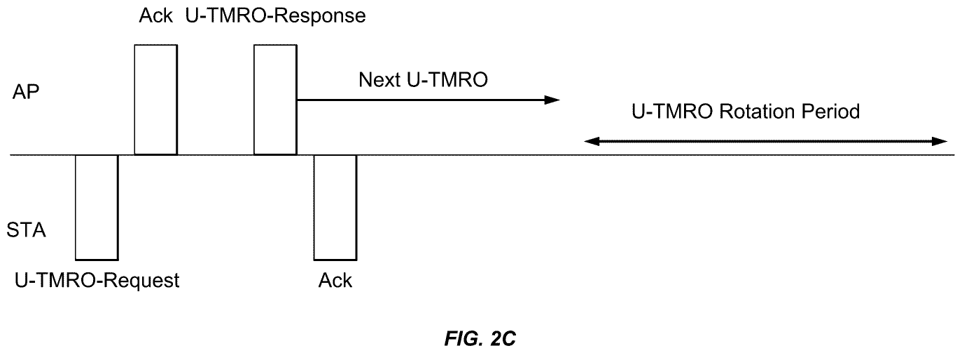

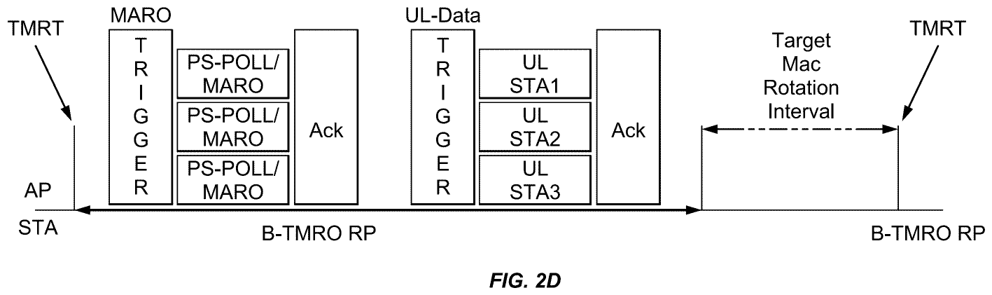

FIG. 2A depicts an exemplary broadcast beacon from an AP (such as the AP 102 in FIG. 1) to a plurality of STAs (such as the STAs 104 and 106 in FIG. 1). The beacon may include multiple MAC address rotation schedules, such as Target MAC Rotation Opportunity (TMRO) 1 and TMRO 2, for the STA to use for rotating its MAC address. In the beacon, the AP includes a duration for which each MAC address rotation schedule is valid, such as the Broadcast TMRO (B-TMRO) Rotation Period (RP) 1 or B-TMRO RP2. If the STA opts into one of the MAC address rotation schedules, then the STA can rotate its MAC address during the specified time of the MAC address rotation schedule. The AP may send another beacon signal with the MAC address rotation schedules after a period of time and continue to do so to ensure that the STAs keep rotating its respective MAC address.

FIG. 2B depicts an exemplary unicast signal (such as the unicast signal 108 in FIG. 1) from an AP (such as the AP 102 in FIG. 1) to a STA (such as the STA 104 or the STA 106), according to one embodiment. The AP may send the STA multiple MAC address rotation schedules without a request from the STA, such as in the Unicast TMRO (U-TMRO) signal. In one embodiment, the AP sends the multiple MAC address rotation schedules to the STA when the STA associates with the AP. In one embodiment, the AP sends the multiple MAC address rotation schedules to the STA after waiting a configurable amount of time since the STA has rotated its MAC address. When the STA receives the multiple MAC address rotation schedules from the AP, the STA may send an acknowledgement back to the AP indicating that the STA received the unicast signal. In one embodiment, the acknowledgement does not include an indicator that the STA opted into one of the MAC addresses rotation schedules. If the acknowledgement included the specific rotation schedule that the STA opted into, then a nefarious actor could determine how to mimic the STA using the same rotation schedule. The STA may rotate its MAC address during the U-TMRO RP. The AP may monitor the STA to determine if the STA decided to change its MAC address according to one of the MAC address rotation schedules.

FIG. 2C depicts an exemplary communication between a STA (such as the STAs 104 and 106 in FIG. 1) and an AP (such as the AP 102 in FIG. 1) for a rotation schedule. The STA may request a MAC address rotation schedule from the AP to follow for rotating its MAC address, such as the U-TMRO-Request. When the AP receives the request from the STA, the AP sends an acknowledgement back to the STA. The AP follows up the acknowledgment with a unicast signal back to the STA with multiple MAC address rotation schedules, such as the U-TMRO-Response. The STA sends an acknowledgement back to the AP indicating that the STA received the multiple MAC address rotation schedules. In one embodiment, the acknowledgement from the STA does not include an indicator that the STA opted into one of the MAC addresses rotation schedules. The STA may rotate its MAC address during the U-TMRO RP. The AP may monitor the STA to determine if the STA decided to change its MAC address according to one of the MAC address rotation schedules. If the AP notices that the STA rotates its MAC address, the AP knows that the STA is sending a message with a new MAC address and that the message is not coming from a nefarious actor. Also, by monitoring the STA, the AP knows when to resend the MAC address rotation schedules to the STA. In one embodiment, if the STA does not rotate its MAC address after an amount of time (that may be configurable), the AP sends the MAC address rotation schedules to the STA for the STA to rotate its MAC address.

FIG. 2D depicts an exemplary embodiment of an AP (such as the AP 102 in FIG. 1) polling to see which STAs (such as the STAs 104 and 106 in FIG. 1) are active to send MAC address rotation schedules. At a Target MAC Rotation Time (TMRT), the AP triggers a polling message sent to each STA associated with the AP and instructs the STAs to go for MAC Address Rotation (MARO). Each of the active STAs sends an acknowledgement back to the AP indicating that the respective STA received the message. The active STAs may be STAs with data that is ready to be transmitted. In one embodiment, the acknowledgement from the STA does not include an indicator that the STA opted to rotate its MAC address. At a second trigger, the AP assigns uplink (UL) resources to the active STAs that acknowledged the message from the AP. The STAs may use the UL resources to send UL data and may send an acknowledgement of the message from the AP. The AP may continue this cycle of triggering a polling message after a set amount of time (which may be configurable) to ensure the STAs associated with the AP are rotating MAC addresses.

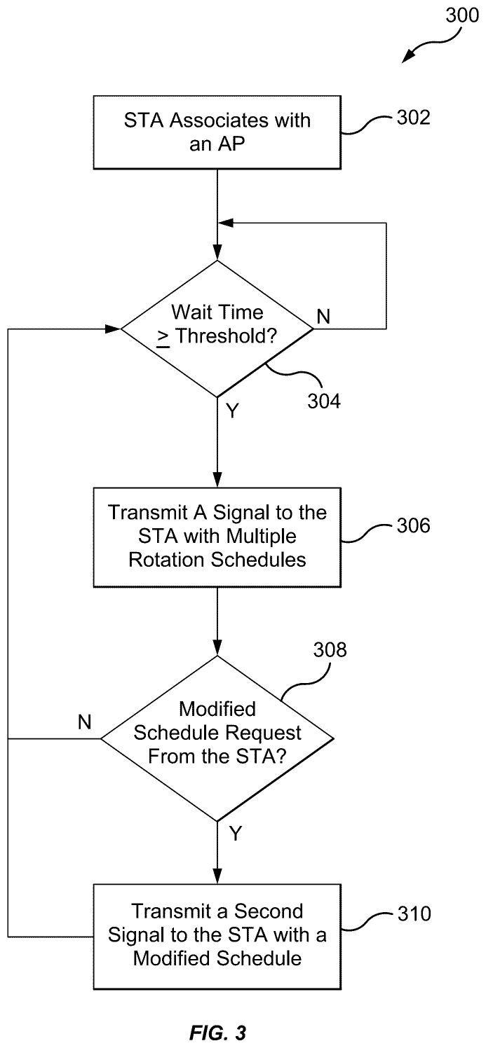

FIG. 3 depicts a flowchart of an exemplary method 300 of transmitting MAC address rotation schedules to a STA (such as the STAs 104 and 106 in FIG. 1) from an AP (such as the AP 102 in FIG. 1). At block 302, the STA associates with the AP. In one embodiment, when the STA associates with the AP, the AP transmits the MAC address rotation schedules to the STA.

At block 304, the AP waits a threshold amount of time to pass before transmitting the MAC address rotation schedules to the STA (or retransmitting the MAC address rotation schedules to the STA in the one embodiment where the AP transmits the MAC address rotation schedules when the STA associates with the AP). The amount of time may be configured by a user, operator, during manufacturing, etc. In one embodiment, the time may be an amount of time since the STA associated with the AP. In one embodiment, the amount of time is an amount of time since the STA rotated its MAC address. A STA may request the AP send the MAC address before the threshold amount of time passes (such as the request 110 in FIG. 1).

At block 306, the AP transmits a signal (such as the unicast signal 108 or the response 112 in FIG. 1) to the STA with multiple MAC address rotation schedules. In one embodiment, the signal is a unicast signal sent to a specific target STA. In one embodiment, the signal is a broadcast signal to multiple STAs associated with the AP including the STA. Each of the MAC address rotation schedules includes a different timing for rotating a MAC address of the STA.

At block 308, the AP determines if the STA sent a request for a modified MAC address rotation schedule. The STA may request a modified schedule of one of the MAC address rotation schedules that the AP transmitted to fit the traffic going to and from the STA. At block 310, the AP transmits a second signal to the STA with the modified schedule and the multiple MAC address rotation schedules. In one embodiment, the AP generates the new MAC address rotation schedule based on a number of STAs associated with the AP. In one embodiment, the AP generates the new MAC address rotation schedule based on traffic going to and from the STA. In one embodiment, the AP generates the new MAC address based on the number of STAs associated with the AP and the traffic going to and from the STA. After the AP transmits the MAC address rotation schedules (and in some embodiments the modified MAC address rotation schedule), the AP waits the threshold amount of time at the block 304 until the AP sends another set of MAC address rotation schedules to the STA.

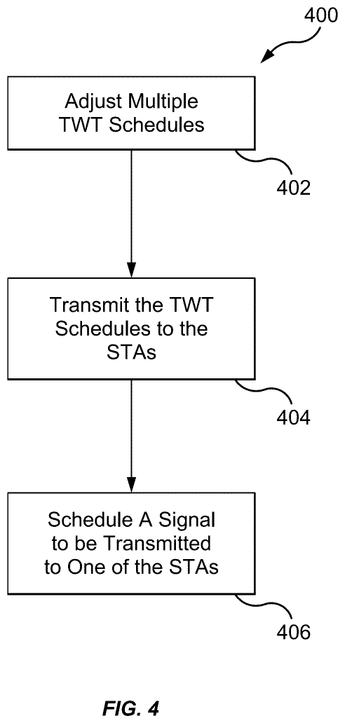

FIG. 4 depicts a flowchart of an exemplary method 400 of an AP (such as the AP 102 in FIG. 1) using a wake time to schedule when a STA (such as the STAs 104 and 106 in FIG. 1) should rotate its MAC address. As the STA is a power save mode (or asleep) according to a wake time schedule, a nefarious actor may determine the STA's MAC address. By having the AP know when it is time for the STA to wake up, the AP may inform the STA to rotate its MAC address, so the nefarious actor does not know the STA's new MAC address. At block 402, the AP adjusts multiple TWT schedules. The TWT schedules can be in any form of time increment such as seconds, or a number of beacons transmitted by the AP. Each of the TWT schedules includes a different time for when the STA should be awake or in the power save mode. The power save mode may be a state when the STA is in a lower power mode than when the STA is awake and actively transmitting/receiving data. In one embodiment, the AP adjusts the TWT schedules based on a number of STAs associated with the AP. In one embodiment, the AP adjusts the TWT schedules based on traffic going to and from the STAs associated with the AP. In one embodiment, the AP adjusts the TWT schedules based on the number of STAs associated with the AP and the traffic going to and from the STAs associated with the AP.

At block 404, the AP transmits the TWT schedules to the STAs. In one embodiment, the AP transmits the TWT schedules in a broadcast signal to each of the STAs associated with the AP. In one embodiment, the AP transmits the TWT schedules in a unicast signal to a specific STA associated with the AP. The STAs may transmit an acknowledgement indicating that the respective STA received the TWT schedules. The STAs may choose to opt into one of the transmitted TWT schedules without notifying the AP of which TWT schedule the STA opted into. The AP may monitor the STAs (such as through traffic going to and from each STA) to determine which of the TWT schedules that the STA opted into. In one embodiment, at least two of the STAs associated with the AP opted into two different TWT schedules.

At block 406, the AP schedules a signal to be transmitted to at least one of the STAs associated with the AP. In one embodiment, the signal from the AP includes an indicator that the STA should rotate its MAC address. When the AP transmits the signal, the STA may send a response back to the AP indicating that the STA is awake.

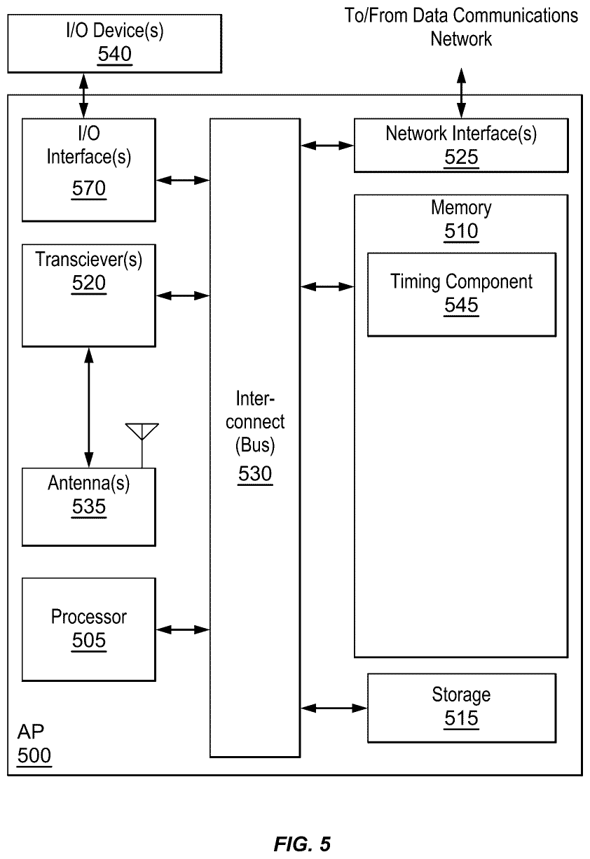

FIG. 5 depicts an example network device 500 configured to perform various aspects of the present disclosure, according to some aspects of the present disclosure. The network device 500 may be an AP, which corresponds to the AP 102 as depicted in FIG. 1.

As illustrated, the example network device 500 includes a processor 505, memory 510, storage 515, one or more transceivers 520, one or more I/O interfaces 580, and one or more network interfaces 525. In some embodiments, I/O devices 540 are connected via the I/O interface(s) 580. Further, via the network interface 525, the network device 500 can be communicatively coupled with one or more other devices and components (e.g., via a network, which may include the Internet, local network(s), and the like). Each of the components is communicatively coupled by one or more buses 530. In some embodiments, one or more antennas 535 may be coupled to the transceivers 520 for transmitting and receiving wireless signals.

The processor 505 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 505 processes information received through the transceiver 520, I/O interfaces 580, and the network interfaces 525. The processor 505 retrieves and executes programming instructions stored in memory 510, as well as stores and retrieves application data residing in storage 515.

The storage 515 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 515 may store a variety of data for the efficient functioning of the system.

The memory 510 may include random access memory (RAM) and read-only memory (ROM). The memory 510 may store processor-executable software code containing instructions that, when executed by the processor 505, enable the network device 500 to perform various functions described herein for wireless communication. In the illustrated example, the memory 510 includes a timing component 545.

The timing component 545 may be configured to track the time since a STA has rotated a MAC address for determining when to transmit the MAC address rotations schedules to the STA as described in FIG. 3. The timing component may also be configured for tracking TWT schedules for the exemplary method described in FIG. 4.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point (AP) comprising:
one or more memories; and
one or more processors communicatively coupled to the one or more memories, wherein the one or more processors are configured to, individually or collectively, perform an operation comprising:
transmitting a signal with a plurality of schedules for rotating a MAC address on a target station, wherein each of the plurality of schedules comprises a different timing for rotating the MAC address; and
monitoring the target station for a change in the MAC address.

2. The AP of claim 1, wherein the operation further comprises:
receiving a request, from the target station, for a modified version of one of the plurality of schedules for rotating the MAC address on the target station; and
transmit a unicast signal to the target station with the plurality of schedules and the modified version of one of the plurality of schedules.

3. The AP of claim 2, wherein the modified version of one of the plurality of schedules is based on traffic going through the target station.

4. The AP of claim 1, wherein the operation further comprises:
determining a plurality of stations associated with the AP, wherein the target station is one of the plurality of stations; and
prior to transmitting the signal, adjusting the plurality of schedules based on a number of the plurality of stations.

5. The AP of claim 1, wherein transmitting the signal further comprises:
determining the target station has not changed the MAC address within a set period of time.

6. The AP of claim 5, wherein the set period of time is an amount of beacons transmitted from the AP.

7. The AP of claim 1, wherein transmitting the signal is in response to the target station associating with the AP.

8. The AP of claim 1, wherein prior to monitoring the target station:
receiving a request from the target station for a schedule for rotating the MAC address on the target station; and
in response to the request from the target station, transmitting a unicast signal to the target station with a second plurality of schedules for rotating the MAC address of the target station.

9. The AP of claim 1, wherein the signal is a broadcast signal to a plurality of stations, wherein the target station is one of the plurality of stations.

10. A method comprising:
transmitting a signal, from an access point (AP), comprising a plurality of schedules for rotating a MAC address on a target station, wherein each of the plurality of schedules comprises a different timing for rotating the MAC address; and
monitoring the target station for a change in the MAC address.

11. The method of claim 10, further comprising:
receiving a request, from the target station, for a modified version of one of the plurality of schedules for rotating the MAC address on the target station; and
transmit a unicast signal to the target station with the plurality of schedules and the modified version of one of the plurality of schedules, wherein the modified version of one of the plurality of schedules is based on traffic going through the target station.

12. The method of claim 10, further comprising:
determining a plurality of stations associated with the AP, wherein the target station is one of the plurality of stations; and
prior to transmitting the signal, adjusting the plurality of schedules based on a number of the plurality of stations.

13. The method of claim 10, wherein transmitting the signal further comprises:
determining the target station has not changed the MAC address within a set period of time.

14. The method of claim 10, wherein transmitting the signal is in response to the target station associating with the AP.

15. The method of claim 10, wherein prior to monitoring the target station:
receiving a request from the target station for a schedule for rotating the MAC address on the target station; and
in response to the request from the target station, transmitting a unicast signal to the target station with a second plurality of schedules for rotating the MAC address of the target station.

16. The method of claim 10, wherein the signal is a broadcast signal to a plurality of stations, wherein the target station is one of the plurality of stations.

17. An access point (AP) comprising:
one or more memories; and
one or more processors communicatively coupled to the one or more memories, wherein the one or more processors are configured to, individually or collectively, perform an operation comprising:
transmitting a first signal to each of a plurality of stations comprising a plurality of schedules each with a different target wake time (TWT), wherein the different TWTs indicate when a respective one of the plurality of stations should be awake or be in a power save mode; and
scheduling a second signal to be transmitted to at least one of the plurality of stations in response to reaching a TWT indicating that the at least one of the plurality of stations should wake up and rotate a MAC address.

18. The AP of claim 17, wherein the TWT is a different time for at least two of the plurality of stations.

19. The AP of claim 18, wherein the TWT is based on a number of beacons transmitted by the AP.

20. The AP of claim 17, wherein the operation further comprises:
prior to transmitting the first signal, adjusting the plurality of schedules based on a number of the plurality of stations, wherein the first signal is a broadcast signal to each of the plurality of stations.
